(19) United States
(12) Patent Application Publication
(10) Pub. No.: US 2007/0239940 A1
(43) Pub. Date: Oct. 11, 2007

(54) Adaptive prefetching

(76) Inventors: Kshitij A. Doshi, Chandler, AZ (US); Quinn A. Jacobson, Sunnyvale, CA (US); Anne Weinberger Bracy, Philadelphia, PA (US); Hong Wang, Fremont, CA (US); Per Hammarlund, Hillsboro, OR (US)

Correspondence Address: CAVEN & AGHEVLI;c/o INTELLEVATE, P.O. BOX 52050, MINNEAPOLIS, MN, 55402, US

(21) Appl. No.: 11/394,914

(22) Filed: Mar. 31, 2006

(51) Int. Cl. G06F 12/00

(52) U.S. Cl. 711/137

(57) ABSTRACT

A technique for adjusting a prefetching rate. More particularly, embodiments of the invention relate to a technique to adjust prefetching as a function of the usefulness of the prefetched data.

### FIELD

Embodiments of the invention relate to microprocessors and microprocessor systems. More particularly, embodiments of the invention pertain to a technique to regulate prefetches of data from memory by a microprocessor.

### BACKGROUND

In modern computing systems, data may be retrieved from memory and stored in a cache within or outside of a microprocessor ahead of when a microprocessor may execute an instruction that uses the data. This technique, known as “prefetching”, allows a processor to avoid latency associated with retrieving (“fetching”) data from a memory source, such as DRAM, by using a history (e.g., heuristic) of fetches of data from memory into respective cache lines to predict future ones.

Excessive prefetching can result if prefetched data is never used by instructions executed by a processor for which the data is prefetched. This may arise for example, from inaccurately predicted or ill-timed prefetches. An inaccurately predicted or an ill-timed prefetch is a prefetch that brings in a line that is not used before the line is evicted from the cache by the normal allocation policies. Furthermore, in a multiple processor system or multi-core processor, excessive prefetching can result in fetching data to one processor that is still being actively used by another processor or processor core. This can hinder the performance of the processor deprived of the data. Furthermore, the prefetching processor may not receive a benefit from the data if the processor deprived of the data originally prefetches or uses the data again. Additionally, excessive prefetching can cause and result from prefetched data being replaced by subsequent prefetches before the earlier prefetched data is used by an instruction.

Excessive prefetching can degrade system performance in several ways. For example, prefetching uses bus resources and bandwidth from the processor to memory. Excessive prefetching, therefore, can increase bus traffic and thereby increase the delay experienced by other instructions with no or little benefit to data fetching efficiency. Furthermore, because prefetched data may replace data already in a corresponding cache line, excessive prefetching can cause useful data to be replaced in a cache by data that may not be used as much or, in some cases, not at all. Finally, excessive prefetching can cause a premature transfer of ownership of prefetched cache lines among a number of processors, or processing cores that may share the cache line, by forcing a processor or a processor core to give up its exclusive ownership of cache lines before it has performed data updates to the cache lines.

### BRIEF DESCRIPTION OF THE DRAWINGS

Embodiments of the invention are illustrated by way of example and not limitation in the figures of the accompanying drawings, in which like references indicate similar elements and in which:

FIG. 1 illustrates a cache memory, in which various cache lines have associated therewith one or more attribute bits, according to one embodiment of the invention.

FIG. 2 illustrates a computer system memory hierarchy in which at least one embodiment of the invention may be used.

FIG. 3 is a flow diagram illustrating operations associated with checking attributes associated with one or more cache lines, according to one embodiment.

FIG. 4 illustrates a shared-bus computer system in which at least one embodiment of the invention may be used.

FIG. 5 illustrates a point-to-point bus computer system in which at least one embodiment of the invention may be used.

FIG. 6 illustrates operations of a prefetch_set instruction, according to one embodiment of the invention.

### DETAILED DESCRIPTION

Embodiments of the invention relate to microprocessors and microprocessor systems. More particularly, embodiments of the invention relate to using memory attribute bits to modify the amount of prefetching performed by a processor.

In one embodiment of the invention, cache lines filled with prefetched data may be marked as having been filled by a prefetch. In one embodiment of the invention, cache lines filled with prefetched data have their attribute cleared when the line is accessed for a normal memory operation. This enables the system to be aware of which cache lines have been prefetched and not yet used by an instruction. In one embodiment, memory attributes associated with a particular segment, or “block”, of memory may be used to indicate various properties of the memory block, including whether data stored in the memory block has been prefetched and not yet used, or prefetched and subsequently used by an instruction, or if a block was not brought in by a prefetch.

If a prefetched cache line is evicted or invalidated without being used by an instruction, then, in one embodiment, a fault-like yield may result in one or more architecturally-programmed scenarios being performed. Fault-like yields can be used to invoke software routines within a program being preformed to adjust the policies for the prefetching of the data causing the fault-like yield. In another embodiment the prefetching hardware may track the number of prefetched lines that are evicted or invalidated before being used, in order to dynamically adjust the prefetching policies without the program's intervention. By monitoring the prefetching of unused data and adapting to excessive prefetching, at least one embodiment allows prefetching to be dynamically adjusted to improve efficiency, reduce useless bus traffic, and help prevent premature eviction or invalidation of cache line data.

In one embodiment, each block of memory may correspond to a particular line of cache, such as a line of cache within a level one (L1) or level two (L2) cache memory, and prefetch attributes may be represented with bit storage locations located within or otherwise associated with a line of cache memory. In other embodiments, a block of memory for which prefetch attributes may be associated may include more than one cache memory line or may be associated with another type of memory, such as DRAM.

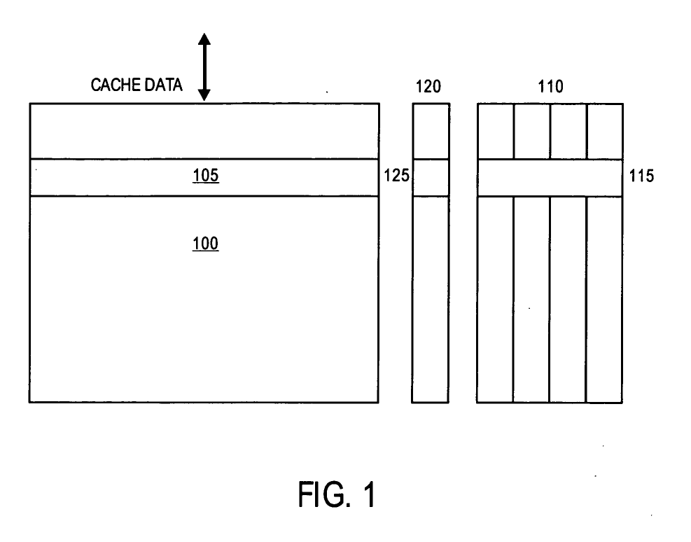

FIG. 1 illustrates a portion of cache memory, each line of which having an associated group of attribute bit storage locations, according to one embodiment of the invention. In particular, FIG. 1 illustrates a cache memory 100 including a cache line 105, which corresponds to a particular block of memory (not shown). The cache line 105 has associated therewith a number of attributes to be stored in the form of bits within storage location 110. In one embodiment, the storage location is an extension of the corresponding cache line, whereas in other embodiments, another type of storage area may be used. Within the storage location 110 is a group of attribute bits 115 associated with cache line 105, which can store bits to represent various properties of the cache line, which can be used by a software program that accesses the cache line.

In the embodiment illustrated in FIG. 1, the group of attribute bits contains four bits, which may represent one or more properties of the cache line, depending upon how the attribute bits are assigned. In one embodiment, the attribute bits indicate whether a corresponding prefetched cache line has been used by an instruction. For example, in one embodiment, data prefetched into one of the cache lines of FIG. 1 may have its corresponding attribute bit set to a “1” value until and unless the data is subsequently used by an instruction being performed by a processor or processor core, in which case the attribute bit for the used data is set to a “0” value. In other embodiments, the attribute bits may designate other permissions, properties, etc.

In addition to the attribute bits, each line of cache may also have associated therewith a state value stored in state storage location 120. For example, in one embodiment the state storage location 120 contains a state bit vector, or a state field, 125 associated with cache line 105 which designates whether the cache line is in a modified state (M), exclusively owned state (E), shared state (S), or invalid state (I). The MESI states can control whether various software threads, cores, or processors can use and/or modify information stored in the particular cache line. In some embodiments the MESI state attribute is included in the attribute bits 115 for cache line 105.

Prefetches are caused by either hardware mechanisms that predict what lines to prefetch or are guided in their prediction by software, or software directives in the form of prefetch instructions or by arbitrary combinations of hardware mechanisms and software directives. Prefetching can be controlled by changing the hardware mechanisms for predicting what lines to prefetch. Prefetching can also be controlled by adding some heuristic for what lines to not prefetch if either a hardware prefetch predictor or software prefetch directive indicates that a prefetch could potentially be done. Policies on prefetching and filtering of prefetches can be handled either for all prefetches or separately for each prefetch based on what address range the prefetched addresses fall within or what part of a program an application is in. The controls for prefetching will be specific to a given implementation and can optionally be made architecturally visible as a set of machine registers.

For example, in one embodiment of this invention, the eviction or invalidation or a prefetched cache line that has not yet been used may result in a change of the policies for what future lines should be prefetched. In other embodiments, a number (“n”) of unused prefetches (indicated by evictions of prefetched cache lines, for example) and/or a number (“m”) of invalidations or evictions of prefetched cache lines may cause the prefetching algorithm to be modified to reduce the number of prefetches of cache lines until the attribute bits and the cache line states indicate that the cache lines that are prefetched are used by instructions more frequently.

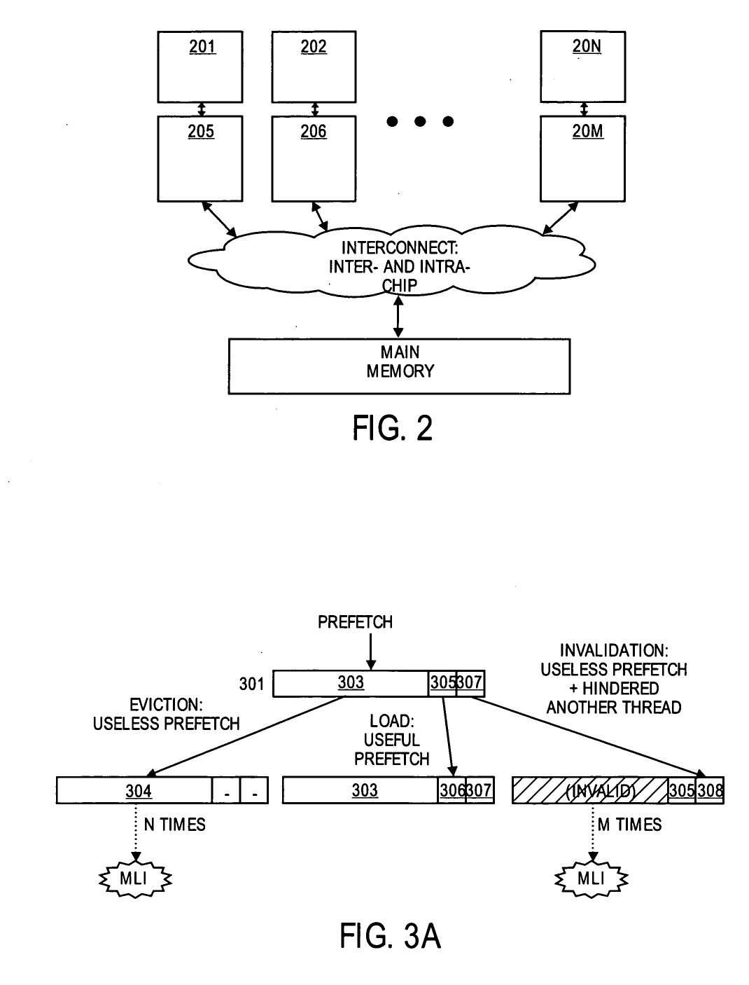

FIG. 2 is a conceptual illustration of how embodiments of the invention may simplify the organization of cache memory from the perspective of a thread of software executing on core of a processor within a computer system. For example, in FIG. 2 each thread can be conceptualized as a single thread core 201-20n having an associated cache memory 205-20m composed of cache lines that are designated to be controlled only by the particular corresponding thread running on the conceptual single-threaded core. For example, in one embodiment, the conceptual cache memories 205-20m may only have their MESI states modified by threads represented by single thread cores 201-20n. Although in reality each of the cache memories 205-20m may be composed of cache lines distributed throughout a cache memory or cache memories, conceptualizing the arrangement in the manner illustrated in FIG. 2 may be useful for understanding certain embodiments of the invention.

In one embodiment of the invention, attributes associated with a block of memory may be accessed, modified, and otherwise controlled by specific operations, such as an instruction or micro-operation decoded from an instruction. For example, in one embodiment an instruction that both loads information from a cache line and sets the corresponding attribute bits (e.g., “load_set” instruction) may be used. In other embodiments, an instruction that loads information from a cache line and checks the corresponding attribute bits (e.g., “load_check” instruction) may be used in addition to or a load_set instruction.

In one embodiment, an instruction may be used that specifically prefetches data from memory to a cache line and sets a corresponding attribute bit to indicate the data has yet to be used by an instruction. In other embodiments, it may be implicit that all prefetches performed by software have attribute bits set for prefetched cache lines. In even other embodiments, prefetches performed by hardware prefetch mechanisms my have attributes set for prefetched cache lines.

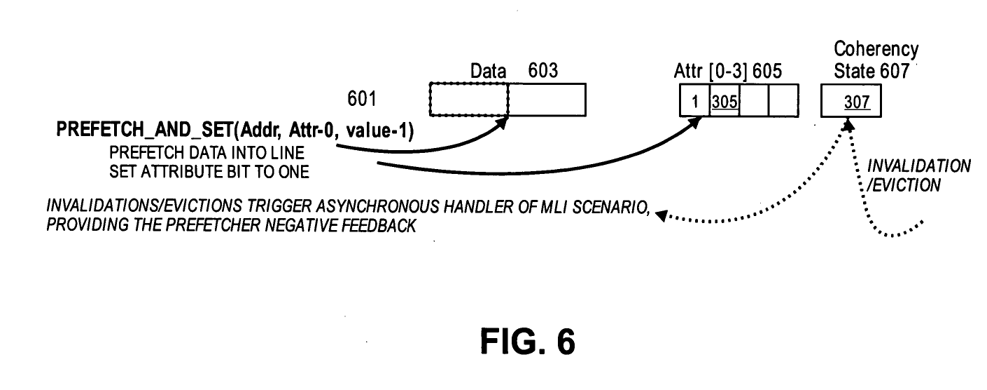

FIG. 6 illustrates the operation of a prefetch_set instruction, according to one embodiment. In one embodiment, cache line 601 may contain prefetched data, attribute bits, and a coherency state variable. In other embodiments, the cache line may contain other information, such as a tag field. Furthermore, in other embodiments, there may be fewer or more attribute bits. In one embodiment, a prefetch_set instruction causes the prefetched data to be stored in the data field 603 of the cache line and an attribute bit in the attribute bit field 605 to be updated with a “1” value, for example. The cache line may be in a “shared” state, such that other instructions or instruction threads may use the data until the cache line is either evicted or invalidated, in which case an architecturally defined scenario, such as a memory line invalidate (MLI) scenario, may be triggered to cause the prefetching to be adjusted accordingly.

If the attribute bits or the cache line state is checked, via, for example, a load_check instruction, one or more architectural scenarios within one or more processing cores may be defined to perform certain events based on the attributes that are checked. There may be other types of events that can be performed in response to the attribute check. For example, in one embodiment, an architectural scenario may be defined to compare the attribute bits to a particular set of data and invoke a light-weight yield event based on the outcome of the compare. The light-weight yield may, among other things, call a service routine which performs various operations in response to the scenario outcome before returning control to a thread or other process running in the system. In another embodiment, a flag or register may be set to indicate the result. In still another embodiment, a register may be written with a particular value. Other events may be included as appropriate responses.

For example, one scenario that may be defined is one that invokes a light-weight yield and corresponding handler upon detecting n number of evictions of prefetched-and-unused cache lines and/or m number of invalidations of prefetched-and-unused cache line (indicated by the MESI states, in one embodiment), where m and n may be different or the same value. Such an architecturally defined scenario may be useful to adjust the prefetching algorithm to more closely correspond to the usage of specific prefetched data from memory.

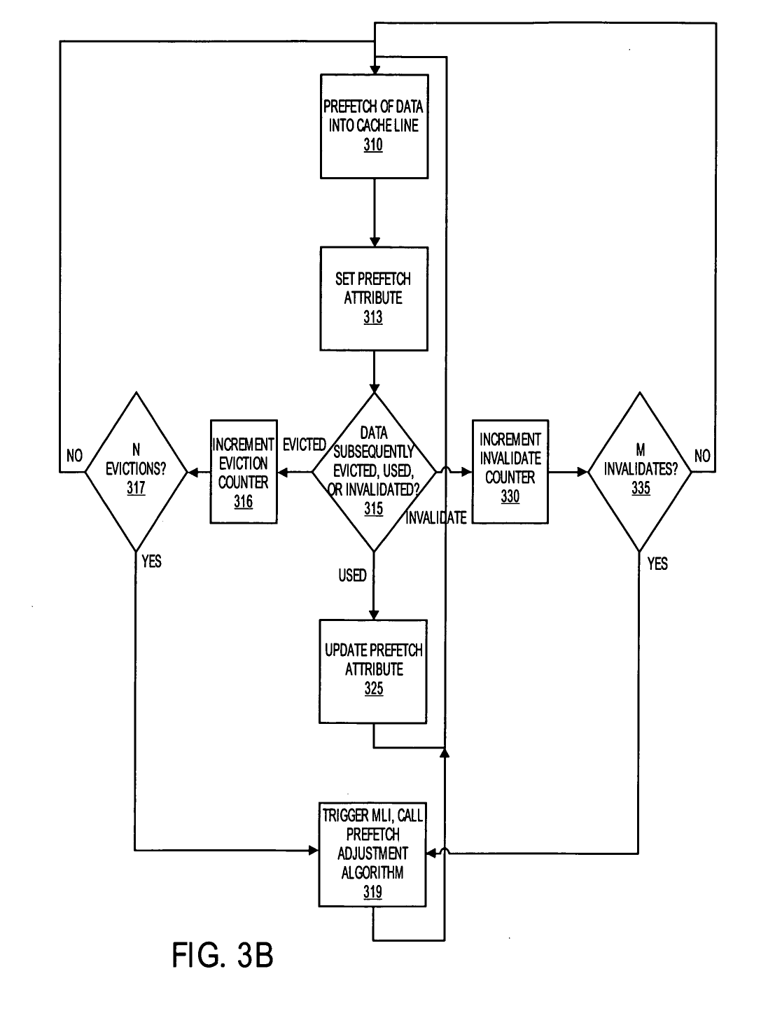

FIG. 3a illustrates the use of attribute bits and cache line states to cause a fault-like yield, which can adjust the prefetching of data, according to one embodiment. In FIG. 3a, prefetched cache line 301 contains prefetched data 303 corresponding to particular memory address, an attribute bit 305, and a state variable 307. If the cache line is evicted, data 303 is replaced with new data 304, and the attribute bit and state variable are irrelevant. After n number of evictions of this or other similarly prefetched and evicted cache lines, an architecturally defined scenario (e.g., memory line invalidate (MLI) scenario) may trigger to cause a prefetch algorithm to adjust the prefetching of the replaced data in order to avoid or at least reduce subsequent useless prefetches of the data. If the cache line is actually used by an instruction, such as a “load” instruction or uop, the data remains in the cache line, the attribute bit 306 changes state (e.g., “1” to “0”) and the state variable remains in the “shared” state, such that the data can continue to be used by subsequent instructions. If the cache line is invalidated, thus preventing other threads from using the data, then the data is indicated to be invalid by state variable 308. After m number of invalidations of prefetched-but-unused data occur, then an MLI scenario may trigger to cause the prefetching algorithm to adjust the prefetching of that data in order to avoid or at least reduce the number of invalidations of the cache line.

In one embodiment, the MLI scenario may invoke a handler that may cause a software routine to be called to adjust prefetching algorithms for all prefetches or only for a subset of prefetches associated with a specific range of data or a specific region of a program. Various algorithms in various embodiments may be used to adjust prefetching. In one embodiment hardware logic may be used to implement the prefetch adjustment algorithm, whereas in other embodiments some combination of software and logic may be used. The particular algorithm used to adjust the prefetching of data in response to the attribute bits and state variables is arbitrary in embodiments of the invention.

FIG. 3b is a flow diagram illustrating the operation of at least one embodiment of the invention in which a prefetch_set instruction and a cache line state variable is used to set prefetch attribute bits associated with a particular cache line in order to dynamically adjust the prefetching of the data to correspond to its usefulness. In other embodiments, other instructions may be used to perform the operations illustrated in FIG. 3b. At operation 310, data is prefetched from a memory address into a cache line and the corresponding attribute is set at operation 313. In one embodiment, this is accomplished by executing a prefetch_set instruction or uop. At operation 315, if the cache line or other cache lines are evicted, an eviction counter is incremented at operation 316 until n number of evictions of data is reached at operation 317, in which case, an architecturally defined scenario (e.g., MLI) is triggered to cause the prefetching algorithm to be adjusted at operation 319. If at operation 315 prefetched data is subsequently used by an instruction (e.g., load instruction/uop), then the attribute bit is updated to reflect this at operation 325. If at operation 315, the data is subsequently invalidated, then the state variable is updated to reflect the invalidated state at operation 330 an invalidation counter is incremented until it reflects an m number of invalidations of the data or other prefetched data at operation 335, in which case an architecturally defined scenario (e.g., MLI) is triggered to cause the prefetching algorithm to be adjusted at operation 319. In other embodiments, other operations may occur before returning to operation 310 from operations 317, 325, or 335, which may affect whether operation returns to operation 310.

Prefetching may be performed in a variety of ways. For example, in one embodiment, prefetching is performed by executing an instruction (e.g., “prefetch_set” instruction), as described above (“software” prefetching or “explicit” prefetching). In other embodiments, prefetching may be performed by hardware logic (“hardware” prefetching or “implicit” prefetching). In one embodiment, hardware prefetching may be performed by configuring prefetch logic (vis-à-vis a software utility program, for example) to set an attribute bit for each prefetched cache line to indicate that the prefetched data within the cache line has not been used. In some embodiments, control information associated with the prefetch logic may be configured to determine which attribute bit(s) is/are to be used for the purpose of indicating whether prefetched data has been used.

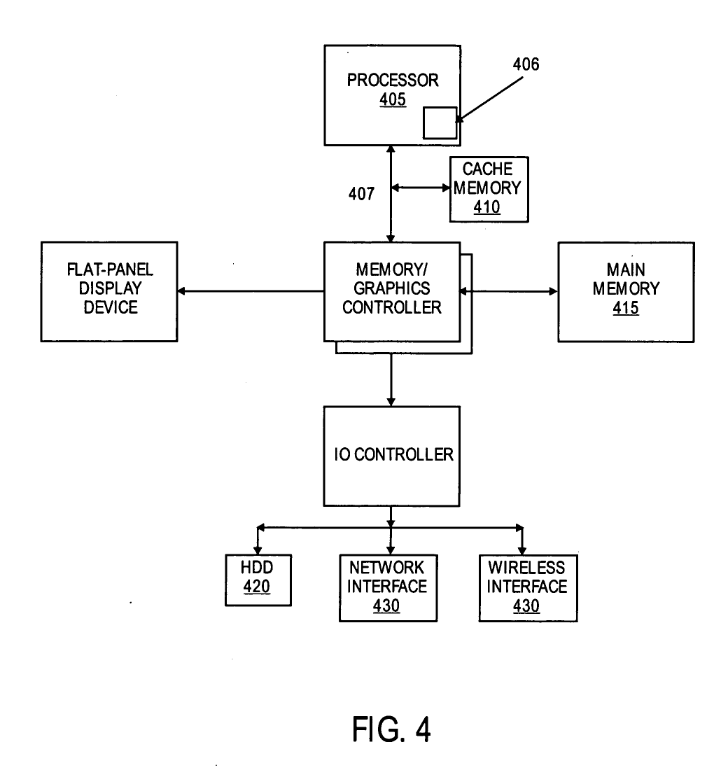

FIG. 4 illustrates a front-side-bus (FSB) computer system in which one embodiment of the invention may be used. A processor 405 accesses data from a level one (L1) cache memory 410 and main memory 415. In other embodiments of the invention, the cache memory may be a level two (L2) cache or other memory within a computer system memory hierarchy. Furthermore, in some embodiments, the computer system of FIG. 4 may contain both an L1 cache and an L2 cache.

Illustrated within the processor of FIG. 4 is a storage area 406 for machine state. In one embodiment storage area may be a set of registers, whereas in other embodiments the storage area may be other memory structures. Also illustrated in FIG. 4 is a storage area 407 for save area segments, according to one embodiment. In other embodiments, the save area segments may be in other devices or memory structures. The processor may have any number of processing cores. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 420, or a memory source located remotely from the computer system via network interface 430 containing various storage devices and technologies. The cache memory may be located either within the processor or in close proximity to the processor, such as on the processor's local bus 407.

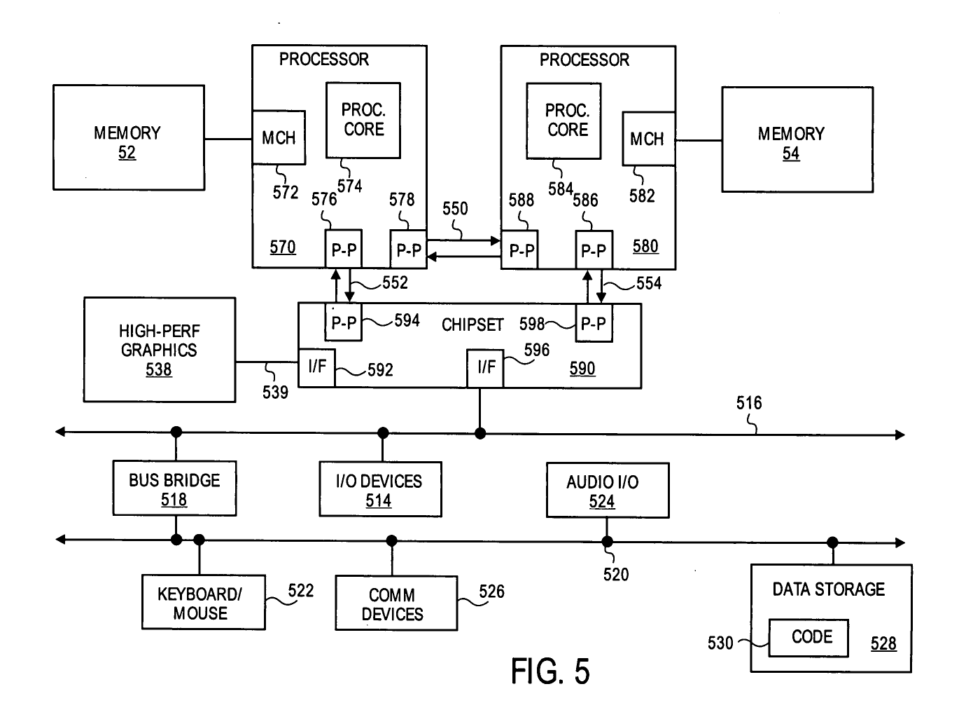

Furthermore, the cache memory may contain relatively fast memory cells, such as a six-transistor (6T) cell, or other memory cell of approximately equal or faster access speed. The computer system of FIG. 4 may be a point-to-point (PtP) network of bus agents, such as microprocessors, that communicate via bus signals dedicated to each agent on the PtP network. FIG. 5 illustrates a computer system that is arranged in a point-to-point (PtP) configuration. In particular, FIG. 5 shows a system where processors, memory, and input/output devices are interconnected by a number of point-to-point interfaces.

The system of FIG. 5 may also include several processors, of which only two, processors 570, 580 are shown for clarity. Processors 570, 580 may each include a local memory controller hub (MCH) 572, 582 to connect with memory 22, 24. Processors 570, 580 may exchange data via a point-to-point (PtP) interface 550 using PtP interface circuits 578, 588. Processors 570, 580 may each exchange data with a chipset 590 via individual PtP interfaces 552, 554 using point to point interface circuits 576, 594, 586, 598. Chipset 590 may also exchange data with a high-performance graphics circuit 538 via a high-performance graphics interface 539. Embodiments of the invention may be located within any processor having any number of processing cores, or within each of the PtP bus agents of FIG. 5.

Other embodiments of the invention, however, may exist in other circuits, logic units, or devices within the system of FIG. 5. Furthermore, in other embodiments of the invention may be distributed throughout several circuits, logic units, or devices illustrated in FIG. 5.

Embodiments of the invention described herein may be implemented with circuits using complementary metal-oxide-semiconductor devices, or “hardware”, or using a set of instructions stored in a medium that when executed by a machine, such as a processor, perform operations associated with embodiments of the invention, or “software”. Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
a cache line having an attribute field to store an attribute bit that is to change state after a first data stored within the cache line has been used by an instruction.

2. The apparatus of claim 1 wherein the cache line is associated with a cache line within a memory block.

3. The apparatus of claim 1 wherein the cache line further includes a state variable field to indicate whether the first data has been invalidated due either to an eviction of the first data or an update of the first data by a second data.

4. The apparatus of claim 3 wherein if the first data has been evicted a first number of times without the first data being used, the rate at which data is prefetched into the cache line is to be adjusted.

5. The apparatus of claim 4 wherein if the first data has been updated by another data a second number of times without the first data being used, the rate at which data is prefetched into the cache line is to be adjusted.

6. The apparatus of claim 5 wherein an architecturally defined scenario is to trigger a handler to cause the rate at which data is prefetched in to the cache line to be adjusted.

7. The apparatus of claim 1 wherein the attribute bit is to be updated by executing the same instruction to prefetch the first data.

8. The apparatus of claim 7 wherein the cache line is within a level one (L1) cache memory.

9. A machine-readable medium having stored thereon a set of instructions, which if executed by a machine cause the machine to perform a method comprising:
reading an attribute bit associated with a cache memory line, the attribute bit to indicate whether prefetched data has been used by a first instruction;
counting a number of consecutive occurrences of a coherency state variable associated with the cache memory line;
performing a light-weight yield event if the number of consecutive occurrences of the coherency state variable is at least a first number.

10. The machine-readable medium of claim 9 wherein the coherency state variable indicates that the cache line is invalid.

11. The machine-readable medium of claim 9 further comprising updating the attribute bit if the prefetched data is used by the first instruction.

12. The machine-readable medium of claim 9 wherein the attribute bit is set as a result of executing a prefetch.

13. The machine-readable medium of claim 12 wherein the first instruction is a load instruction.

14. The machine-readable medium of claim 12 wherein the attribute set by executing a prefetch_set instruction.

15. The machine-readable medium of claim 10 wherein fault-like yield is to trigger an architecturally defined scenario to cause the prefetched data to be prefetched less frequently.

16. A system comprising:
a memory to store a first instruction to cause a first data to be prefetched and to update an attribute bit associated with the first data, the attribute to indicate whether the first data has been used by an instruction;
at least one processor to fetch the first instruction and prefetch the first data in response thereto.

17. The system of claim 16 wherein the attribute is to be stored in a cache line into which the first data is to be prefetched.

18. The system of claim 17 further comprising an eviction counter to count a number of consecutive evictions of the first data from the cache line.

19. The system of claim 18 further comprising an invalidate counter to count a number of consecutive times the first data is invalidated in the cache line.

20. The system of claim 19 wherein if the number of consecutive evictions is equal to a first value or the number of consecutive invalidates is equal to a second value, a light-weight yield event is to occur.

21. The system of claim 20 wherein the light-weight yield event is to cause the rate of prefetching to be adjusted.

22. The system of claim 16 wherein the first instruction is a prefetch_set instruction.

23. The system of claim 16 wherein the attribute bit is one of a plurality of attribute bits associated with the cache memory line.

24. The system of claim 23 wherein the plurality of attribute bits are user-defined.

25. A processor comprising:
a fetch unit to fetch a first instruction to prefetch a first data into a cache line and set an attribute bit to indicate whether the first data is used by a load instruction;
logic to update the attribute bit if the first data is used by the load instruction after it has been prefetched.

26. The processor of claim 25 further comprising a plurality of processing cores, each able to execute a plurality of software threads.

27. The processor of claim 26 further comprising logic to perform an architecturally defined scenario to detect whether the first data is invalidated or evicted from the cache line a consecutive number of times.

28. The processor of claim 27 wherein the cache line may be in one of a plurality of states consisting of: modified state, exclusive state, shared state, and invalid state.

29. The processor of claim 28 further comprising a cache memory in which the cache line is included.

30. The processor of claim 25 wherein the first instruction is a prefetch_set instruction.

31. An apparatus comprising:
detection means for detecting whether a prefetched cache line has been evicted or invalidated before being used.

32. The apparatus of claim 31 further comprising a yield means for performing a fault-like yield in response to the detection means detecting that a prefetched cache line has been evicted or invalidated before being used.

33. The apparatus of claim 32 wherein the yield means is to cause a change in a prefetch policy for at least one memory address corresponding to at least one prefetched cache line.

34. The apparatus of claim 33 wherein the prefetch policy is to be controlled by logic having at least one control means for controlling prefetching of a range of memory addresses.

35. The apparatus of claim 33 further comprising a counter means for counting a number of prefetched data that are evicted or invalidated before being used.

36. The apparatus of claim 35 wherein if the counter means counts a first number of unused prefetched data, then the yield means is to generate a fault-like yield.

37. The apparatus of claim 33 wherein the prefetch policy is to be controlled by software having at least one control means for controlling prefetching of a range of memory addresses.
